(19) United States
(12) Patent Application Publication
(10) Pub. No.: US 2026/0177029 A1
(43) Pub. Date: Jun. 25, 2026

(54) DETERMINING WIND SPEED AT A WIND TURBINE

(71) Applicant: VESTAS WIND SYSTEMS A/S, Aarhus N (DK)

(72) Inventors: Anders Druedahl THURLOW, Silkeborg (DK); Sara SINISCALCHI MINNA, Aarhus C (DK); Julio Xavier Vianna NETO, Skødstrup (DK)

(21) Appl. No.: 19/128,250

(22) PCT Filed: Nov. 7, 2023
(86) PCT No.: PCT/DK2023/050270

§ 371 Date: May 8, 2025

(30) Foreign Application Priority Data
Nov. 9, 2022 (DK) PA202270543

(51) Int. Cl. F03D 7/04; F03D 7/02

(52) U.S. Cl. CPC F03D 7/042; F03D 7/0224

(57) ABSTRACT

The invention relates to determining wind speed at a wind turbine comprising a rotor and a plurality of rotor blades. The invention involves receiving a rotor speed signal indicative of current speed of the rotor and receiving a pitch angle signal indicative of current pitch angle of the rotor blades. For each of a plurality of wind speeds, a first thrust force on the rotor is obtained based on the received rotor speed and pitch angle signals. The invention involves receiving a blade flap load signal, from a blade flap load sensor of each of the rotor blades, indicative of measured flap loading on the rotor blades, and obtaining a second thrust force on the rotor using a defined blade element model and the received blade flap load signal. The first thrust forces are compared against the second thrust force, and wind speed is determined based on the comparison.

### TECHNICAL FIELD

The present invention relates to determining wind speed at a wind turbine. In particular, the invention uses an estimation of thrust force on a rotor of the wind turbine based on measurements of flap loading on rotor blades of the wind turbine in order to determine wind speed.

### BACKGROUND

Wind turbines typically include one or more controllers for controlling various components of the wind turbine. For instance, wind turbine controllers may be used to control pitch angle of rotor blades of the wind turbine and/or a speed of a generator of the wind turbine. Wind turbine controllers may control components with the aim of maximising power production/energy captured by the wind turbine from the wind, and/or minimising loads experienced by various wind turbine components during operation.

Wind turbine controllers typically determine control actions or set points for the components based on various operational parameters associated with operation of the wind turbine. In particular, knowledge of current wind speed in the vicinity of a wind turbine is often used by wind turbine controllers to determine appropriate control actions.

There are various known ways in which wind speed flowing past a wind turbine is obtained. For instance, direct measurement of the wind speed may be performed. In particular, one or more sensors, e.g. anemometers, may be positioned on or near a wind turbine, e.g. mounted to a nacelle of the wind turbine, for this purpose. Such wind speed measurements can suffer the drawbacks of having relatively high levels of noise and being unreliable. Also, in many cases it is desired the ‘rotor effective’ wind speed—i.e. a wind speed representative of wind speed across an entire rotor area of the wind turbine (wind speed experienced by the rotor), rather than at a single measurement point—that is of interest for use by wind turbine controllers. Another option is therefore to estimate the wind speed flowing past the wind turbine. There are various ways in which this may be implemented. In one example, wind speed may be estimated based on a rotational speed of the wind turbine rotor, a (collective) pitch angle of the wind turbine rotor blades, and on rotor power output.

In both cases—measurement or estimation—filtering may be applied to remove high frequency noise. This may be implemented directly by applying a low pass filter to the measured signal or to the input and/or output signal(s) of a wind speed estimator. Alternatively, some typical wind speed estimation methods that are used, e.g. integral-based methods, act as a low pass filter as part of the estimation.

An issue exists in that some wind turbine controllers need to react—i.e. provide suitable control actions—to relatively fast changes in wind speed. For instance, a controller for limiting thrust loads experienced by the wind turbine rotor needs to react to wind gusts, i.e. relatively fast rises in wind speed with significant magnitude. However, filtering out high frequency content from the wind speed measurement or estimation as mentioned above can result in not only high frequency noise being removed as desired, but can also result in these faster (i.e. shorter timescale) wind speed changes being filtered out from the measurement or estimation. In some wind speed estimator methods that act as a low pass filter, there is a lag in high frequency content in the estimated wind speed. In either case, this can result in non-optimal performance of controllers that rely on determinations of wind speed that include these shorter timescale changes.

It is against this background to which the present invention is set.

### SUMMARY OF THE INVENTION

According to an aspect of the present invention there is provided a method of determining wind speed at a wind turbine comprising a rotor and a plurality of rotor blades. The method comprises receiving a rotor speed signal indicative of current speed of the rotor. The method comprises receiving a pitch angle signal indicative of current pitch angle of the rotor blades. The method comprises, for each of a plurality of wind speeds, obtaining a first thrust force on the rotor based on the received rotor speed signal and on the received pitch angle signal. The method comprises receiving a blade flap load signal, from a blade flap load sensor of each of the rotor blades, indicative of measured flap loading on the rotor blades. The method comprises obtaining a second thrust force on the rotor using a defined blade element model and the received blade flap load signal. The method comprises comparing the first thrust forces against the second thrust force, and determining wind speed based on the comparison.

The determined wind speed may be the wind speed corresponding to the first thrust force that is closest to the second thrust force.

Comparing the first thrust forces against the second thrust force may comprise performing an interpolation of the first thrust forces to obtain an interpolated function describing thrust force against wind speed. The determined wind speed may be the wind speed at which the interpolated function is equal to the second thrust force.

Each of the plurality of wind speeds may be within a defined range of wind speeds and at defined increments within the defined range. Optionally, the defined increment may be between 0.1 m/s and 2 m/s. Further optionally, the defined increment may be 0.1 m/s, 0.2 m/s, 0.5 m/s, 1 m/s or 2 m/s. Optionally, a lower bound of the defined range may be between 0 m/s and 5 m/s. Further optionally, the lower bound may be 0.5 m/s, 1 m/s, 2 m/s, 3 m/s, 4 m/s or 5 m/s. Optionally, an upper bound of the defined range may be between 20 m/s and 40 m/s. Further optionally, the upper bound may be 25 m/s, 30 m/s, 35 m/s or 40 m/s.

The method may comprise obtaining a first wind speed signal, wherein the first wind speed signal may be obtained by estimating wind speed based on one or more received operational parameter signals indicative of current operational parameters of the wind turbine or by measuring wind speed using one or more wind speed sensors of the wind turbine. The first wind speed signal may be a filtered signal to retain low frequency content.

The method may comprise obtaining a second wind speed signal, wherein obtaining the second wind speed signal may comprise determining wind speed according to the method of any previous claim. The second wind speed signal may be a filtered signal to retain high frequency content.

The method may comprise combining the first wind speed signal and the second wind speed correction signal to determine the wind speed.

Combining the first and second wind speed signals may comprise adding the first and second wind speed signals.

Obtaining the second wind speed signal may comprise applying a high pass filter to the wind speed obtained from the comparison of the first thrust forces against the second thrust force.

The first wind speed signal may be obtained by measuring wind speed using one or more wind speed sensors of the wind turbine. The method may comprise applying a low pass filter to the measured wind speed to obtain the first wind speed signal.

The first wind speed signal may be obtained by estimating wind speed based on one or more received operational parameter signals indicative of current operational parameters of the wind turbine. The operational parameters may include current rotor speed and current pitch angle. The filtering to retain low frequency content may be achieved by one or more of: applying a low pass filter to the one or more received operational parameter signals; and, applying a low pass filter to the estimation of wind speed.

The first wind speed signal may be obtained by estimating wind speed based on one or more received operational parameter signals indicative of current operational parameters of the wind turbine. The estimation of wind speed may be based on estimated rotor power of the wind turbine. The estimated rotor power may be estimated based on one or more operational parameters of the wind turbine. The estimation of wind speed may be obtained using an integral controller and the estimated rotor power.

Using the integral controller may comprise: receiving a measured rotor power indicative of output power and power loss of the wind turbine; determining an error between the measured rotor power and the estimated rotor power; and, integrating the error over time to obtain the first wind speed signal.

According to another aspect of the invention there is provided a non-transient, computer-readable storage medium storing instructions thereon that when executed by one or more processors cause the one or more processors to execute a method as defined above.

According to another aspect of the invention there is provided a controller for determining wind speed at a wind turbine comprising a rotor and a plurality of rotor blades. The controller is configured to receive a rotor speed signal indicative of current speed of the rotor. The controller is configured to receive a pitch angle signal indicative of current pitch angle of the rotor blades. The controller is configured to, for each of a plurality of wind speeds, obtain a first thrust force on the rotor based on the received rotor speed signal and on the received pitch angle signal. The controller is configured to receive a blade flap load signal, from a blade flap load sensor of each of the rotor blades, indicative of measured flap loading on the rotor blades. The controller is configured to obtain a second thrust force on the rotor using a defined blade element model and the received blade flap load signal. The controller is configured to compare the first thrust forces against the second thrust force, and determine wind speed based on the comparison.

According to another aspect of the invention there is provided a wind turbine comprising a controller as defined above.

### BRIEF DESCRIPTION OF THE DRAWINGS

Examples of the invention will now be described with reference to the accompanying drawings, in which:

FIG. 1 schematically illustrates a wind turbine in accordance with an aspect of the invention;

FIG. 2 shows the steps of a method of determining wind speed at the wind turbine of FIG. 1 in accordance with an aspect of the invention;

FIG. 3 shows a plot of thrust force on a rotor of the wind turbine of FIG. 1 as a function of wind speed, determined in accordance with the method of FIG. 2;

FIG. 4 schematically illustrates a control module arrangement for determining wind speed, the arrangement being implemented by a controller of the wind turbine of FIG. 1 and using the method of FIG. 2; and,

FIG. 5 schematically illustrates an integral controller module to be implemented by the arrangement of FIG. 4.

### DETAILED DESCRIPTION

Examples of the invention advantageously provide for determining wind speed at a wind turbine where relatively fast changes in wind speed, e.g. as a result of wind gusts, are captured in the determination, but without the determination suffering from having significant levels of high frequency noise. The determined wind speed can be used as a standalone determination of overall wind speed, or can be used to correct wind speed obtained from a different source to include high frequency content, i.e. shorter-timescale changes.

Examples of the invention make use of the fact that the effects of relatively fast changes in wind speed are exhibited initially by the rotor blades of a wind turbine. Examples of the invention therefore use measurements of loading experienced by the rotor blades as part of the wind speed determination in order to capture shorter timescale changes in the wind speed via a measurement or estimation of rotor thrust force, as described in more detail below. Measured blade load signals include less noise than some other methods of measuring or estimating wind speed.

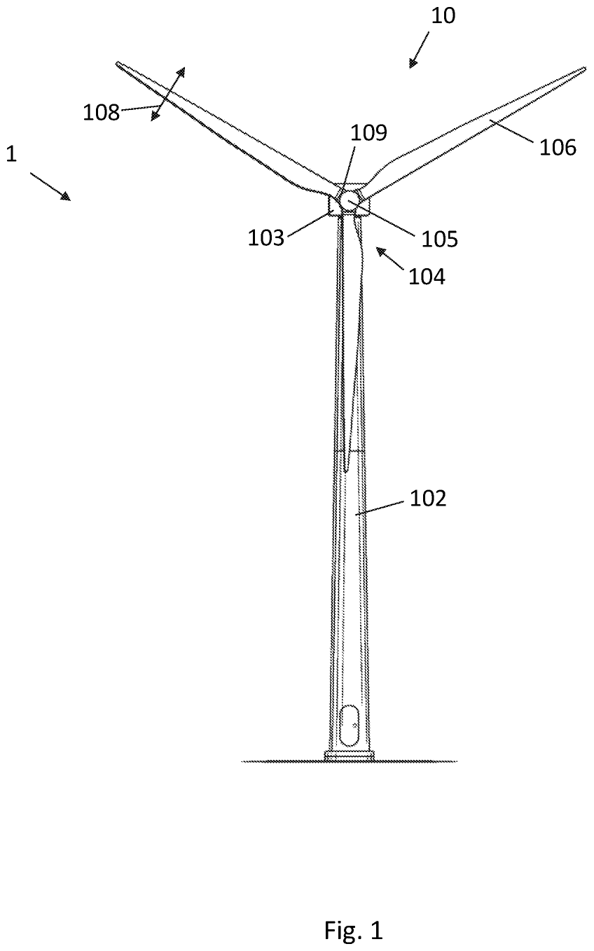

FIG. 1 illustrates, in a schematic view, an example of a wind turbine 10. The wind turbine 10 includes a tower 102, a nacelle 103 disposed at the apex of, or atop, the tower 102, and a rotor 104 operatively coupled to a generator housed inside the nacelle 103. In addition to the generator, the nacelle 103 houses other components required for converting wind energy into electrical energy and various components needed to operate, control, and optimise the performance of the wind turbine 10. The rotor 104 of the wind turbine 10 includes a central hub 105 and three rotor blades 106 that project outwardly from the central hub 105. The rotor blades 106 are pitch-adjustable. The rotor blades 106 can be adjusted in accordance with a collective pitch setting, where each of the blades are set to the same pitch value. The rotor blades 106 may additionally be adjustable in accordance with individual pitch settings, where each blade 106 may be provided with an individual pitch setpoint.

The wind turbine 10 includes blade load sensors placed at, or in the vicinity of, each blade root 109 in a manner such that the sensor detects loading in the blade 106. Blade load signals from such sensors may be used to determine how to adjust the pitch of each of the individual blades 106. Depending on the placement and the type of sensor, loading may be detected in the flap (flapwise) direction (in/out of plane) or in the edge (edgewise) direction (in-plane). Such sensors may be strain gauge sensors or optical Bragg-sensors, for instance.

A method for determining wind speed at the wind turbine 10 in accordance with examples of the invention is now described. The wind speed being determined may be regarded as being the speed of the wind in the vicinity of the wind turbine 10, or the rotor effective wind speed, i.e. a wind speed representative of wind speed across the swept area of the rotor blades 106, for instance. The method may be implemented by a controller or other processing module associated with the wind turbine 10. In examples, the controller or processing module may be located in the wind turbine 10, e.g. inside the nacelle 103, in the tower 102 or distributed at a number of locations inside the turbine 10 and communicatively connected to one another. Alternatively, the controller (or part thereof) may be located externally to the wind turbine 10. The controller may be in the form of any suitable computing device, for instance one or more functional units or modules implemented on one or more computer processors. Such functional units may be provided by suitable software running on any suitable computing substrate using conventional or customer processors and memory. The one or more functional units may use a common computing substrate (for example, they may run on the same server) or separate substrates, or one or both may themselves be distributed between multiple computing devices. A computer memory may store instructions for performing the methods performed by the controller, and the processor(s) may execute the stored instructions to perform the method.

The described method makes use of different approaches for estimating or measuring thrust force experienced by the wind turbine rotor 104, i.e. a total (aerodynamic) force acting on the rotor 104 in a direction along the axis of rotation of the rotor 104. In particular, results from a first approach for determining rotor thrust that does depend on wind speed are compared against results from a second approach for determining rotor thrust that does not depend on wind speed, where a determination of wind speed is made based on the comparison.

An example of a model or equation for rotor thrust force in line with the first approach, i.e. where the rotor thrust determination is dependent on wind speed, is

$${F}_{t} = \frac{1}{2} ρ {R}^{2} {C}_{t} ( θ , \frac{ω R}{V} ) {V}^{2}$$

where Fₜ is the thrust force, ρ is air density, R is a radius of the rotor 104, V is wind speed, θ is pitch angle of the rotor blades 106, ω is rotational speed of the rotor 104, and the thrust coefficient Cₜ is a defined function of pitch angle θ and tip speed ratio ωR/V.

The thrust coefficient function may typically be in the form of a look up table calculated offline and stored in a memory accessible by the controller implementing the method. In particular, the look up table may include a plurality of thrust coefficient values each corresponding to a respective pair of pitch angle and tip speed ratio values.

It is noted that rearranging the above equation to be an expression for wind speed, i.e. rearranging the above equation to isolate V, would require a different expression of the relationship between thrust coefficient Cₜ and wind speed V.

The described example instead provides a different way to solve the above equation for wind speed V. In particular, the described example obtains an estimate or measurement of rotor thrust force using another, second approach, as mentioned above. In particular, rotor thrust is determined using a defined blade element model and a measured flap load experienced by the rotor blades 106. The measured flap load, i.e. the loading in the flap direction of the blades, is obtained from the blade load sensors, for instance by combining, e.g. averaging, the measured flap load signal obtained from the sensor of each rotor blade 106. Alternatively, the measured flap load may be based on a flap load signal from only one of the blade load sensors. The blade flap load measurement is indicative of the bending moment at the root 109 of the rotor blade 106.

As is known in the art, a blade element model (or blade element momentum model) breaks down a rotor blade into several small parts/elements (along its span) and then determines the forces on each of these elements. These forces are then integrated across the entire blade and over one rotor rotation of the blade to obtain the forces and moments experienced by the rotor blade. In the present context, a blade element model provides a signal that can map a sum of measured flap loads (moment/torque) of unit Nm into a rotor thrust force of unit N, i.e. the mapping signal of unit 1/m. Specifically, the BEM may calculate forces and moments on the rotor blade 106 based on lift and drag curves for the rotor 104. The forces and moments are represented at a centre of the rotor hub/an intersection point of the rotor blades 106; however, as mentioned above, the blade load sensors are positioned at a root of the rotor blades 106, which is some radius or distance out from the centre of the rotor hub. This is used to obtain rotor thrust force from the blade flap loads measured by the blade load sensors of the rotor blades 106.

More formally, in one example the following relationships may be used to obtain rotor thrust force using blade load measurements.

$${M}_{H C} = {r}_{c} {F}_{H C}$$

where M_{HC} is the moment at the hub centre, F_{HC} is the force at the hub centre, and r_{c} is the pressure centre radius. Assuming an even distribution of moment from the pressure centre radius gives

$${M}_{H C} = \frac{{r}_{c}}{{r}_{c} - {r}_{m}} {M}_{m e a s} = C {M}_{m e a s}$$

where rₘ is the measurement radius, Mₘₑₐₛ is the measured blade moment, and C=r_{c}/(r_{c}−rₘ) is a correction factor. Then,

$${F}_{H C} = \frac{c}{{r}_{c}} {M}_{m e a s}$$

and a flap moment sum to thrust force factor may be defined as K=C/r_{c} (which has unit 1/m).

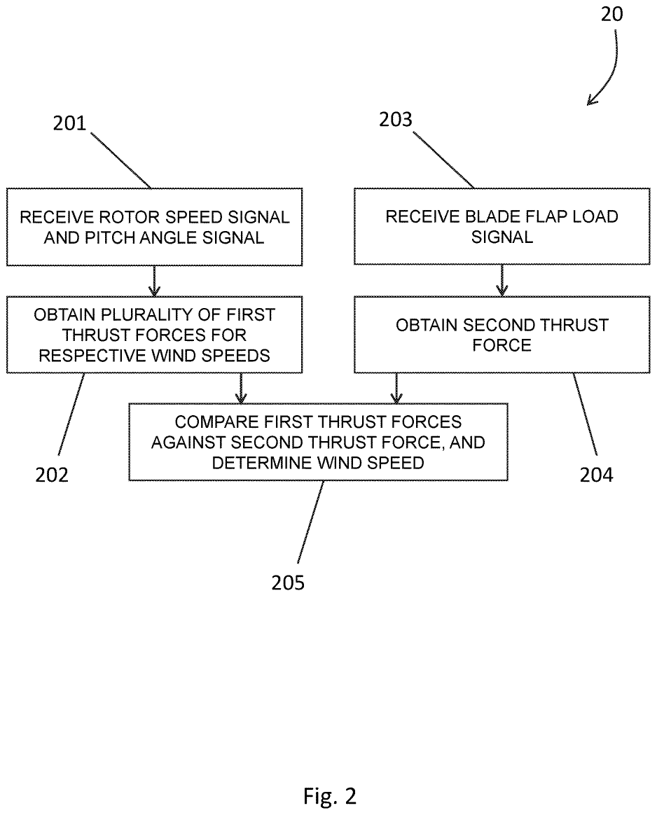

FIG. 2 schematically illustrates the steps of a method 20 for determining wind speed in accordance with examples of the invention. Referring back to the equation for thrust force Fₜ above, it is apparent that values of rotor speed ω and pitch angle are needed θ to evaluate the equation for thrust force (while noting that both the air density p and rotor radius R are known, constant values). As such, step 201 of the method 20 involves obtaining signals indicative of current rotor speed and of current pitch angle (which may also be referred to collectively as current operating point of the wind turbine 10). In particular, the received rotor speed signal may be indicative of a measured rotational speed of the rotor. This may be performed in any suitable manner. For instance, the rotor speed signal may be received from a suitable sensor for measuring rotor speed, e.g. an encoder. The received pitch angle signal may be indicative of a collective pitch angle setting for the rotor blades 106 of the wind turbine 10. For instance, the wind turbine 10 may include a pitch controller for transmitting a collective pitch reference (to a pitch actuator system of the wind turbine 10) in accordance with which the pitch angle of the rotor blades 106 is to be controlled. The received pitch angle signal may therefore be the collective pitch reference from such a pitch controller.

The wind speed is unknown and the above equation for thrust force Fₜ cannot be rearranged as an expression for wind speed V. Instead, at step 202 of the method 20 the above equation is evaluated to obtain a thrust force value for each of a plurality of (possible) wind speeds. Each of these obtained thrust forces may be referred to as first thrust forces. In particular, for a given possible wind speed, the tip speed ratio ωR/V is determined (using the rotor speed signal) and then the thrust coefficient Cₜ is determined based on the received pitch angle signal and the determined tip speed ratio, e.g. via a look up table. The thrust force Fₜ corresponding to this given wind speed is then obtained by evaluating the above equation.

The thrust force may be obtained as described above for any suitably defined plurality of wind speeds. For instance, the thrust force may be obtained for wind speeds at defined increments within a defined range. In one example, the thrust force may be obtained at 1 m/s increments within a range from 2 m/s to 35 m/s. More generally, the defined increment may be between 0.1 m/s and 2 m/s. For instance, the defined increment may be 0.1 m/s, 0.2 m/s, 0.5 m/s, 1 m/s or 2 m/s. In different examples, the wind speeds at which thrust force is obtained may not be in increments of constant value. For instance, thrust force may be obtained for a greater number of possible wind speeds in a range of wind speeds considered more likely to correspond to the actual wind speed. A lower bound of a range of wind speeds considered may be between 0 m/s and 5 m/s. For instance, the lower bound may be 0.5 m/s, 1 m/s, 2 m/s, 3 m/s, 4 m/s or 5 m/s. An upper bound of a range of wind speeds considered may be between 20 m/s and 40 m/s. For instance, the upper bound may be 25 m/s, 30 m/s, 35 m/s or 40 m/s. It will be understood that the values provided above are merely exemplary.

At step 203 of the method 20, the blade flap load signal is received. In particular, measured flap loading on the rotor blades 106 is obtained from one or more blade load sensors of the rotor blades 106. If a measurement from more than one blade load sensor is obtained, then the received signals may be combined in any suitable manner to obtain a measured blade flap load. At step 204, the method 20 involves obtaining a rotor thrust force value using the received blade flap load signal and a defined blade element model. This thrust force value may be referred to as a second thrust force.

Steps 201 and 202 of the method 20 may be performed in parallel with steps 203 and 204, or steps 201 and 202 may be performed before or after steps 203 and 204.

At step 205, the method 20 involves comparing the plurality of first thrust forces (obtained in step 202) against the second thrust force (obtained in step 204). This comparison is then used to make a determination of wind speed at the wind turbine 10. The comparison and determination may be performed in different ways. In one example, the particular first thrust force (from the plurality of first thrust forces) having a value closest to that of the second thrust force is identified (i.e. the first thrust force that minimises a difference between the first and second thrust forces), and the wind speed is determined to be the wind speed corresponding to said particular thrust force. In another example, an interpolation of the plurality of first thrust forces is performed to obtain a function describing the thrust force against wind speed. The wind speed at which the interpolated function value equals the second thrust force is then identified as the determined wind speed.

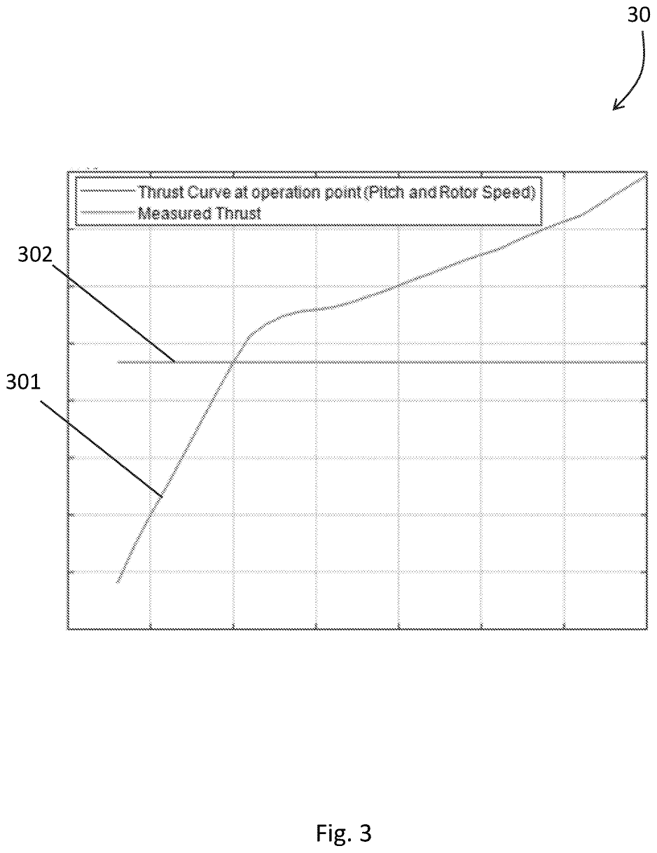

FIG. 3 shows a plot 30 of a curve 301 describing a plurality of first thrust forces at respective wind speeds for a current operating point determined in accordance with an example of the invention. In the illustrated example, the (first) thrust force is determined at 1 m/s increments between 2 m/s and 35 m/s, and the curve 301 is determined based on these discrete evaluation points. FIG. 3 also shows the value of the (second) thrust force 302 obtained via measured blade flap load signals as described above. In the illustrated example, the curve 301 and the value 302 intersect at approximately 10 m/s, and so the wind speed at the wind turbine is determined to be 10 m/s.

While the described method may be used for obtaining an overall determination of wind speed, in examples of the invention the described method for determining wind speed may be used to capture wind speed changes caused by high frequency content, with this determination then being combined with another determination of wind speed that includes low frequency content. This may be advantageous in that, while the above-described method benefits from the inclusion of high frequency content in the wind speed determination, other methods may provide a more accurate determination of wind speed for low frequency content. This is described in greater detail below.

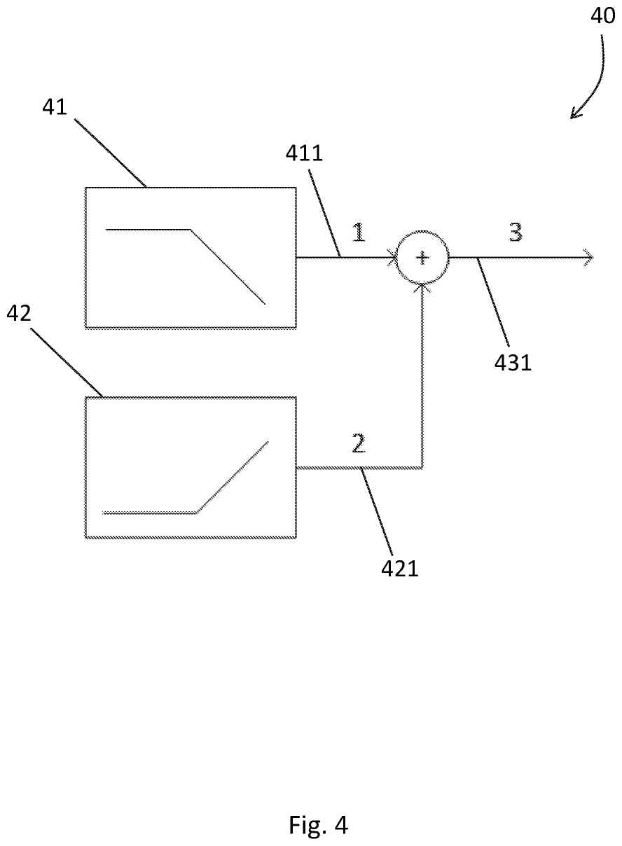

FIG. 4 schematically illustrates a processing or control module arrangement 40 that may be implemented by a controller of the wind turbine 10 in accordance with examples of the invention. In particular, a first wind speed signal 411 is obtained from a first processing or control module 41 and a second wind speed signal 421 is obtained from a second processing or control module 42. The first and second wind speed signals 411, 421 are then combined to obtain a signal 431 providing an overall determination of wind speed at the wind turbine 10. The second wind speed signal 421 may be regarded as a correction signal, in that it is combined with the first wind speed signal 411 to correct the wind speed according to the first wind speed signal 411 to include the effects of high frequency content, i.e. to regain some of the faster changes in wind speed that may be filtered out by the method used to obtain the first wind speed signal 411.

The first processing module 41 makes a determination of wind speed at the wind turbine 10 for low frequency content. This can be performed in any suitable manner. In one example, the first processing module 41 receives a measured wind speed signal and applies a low pass filter to remove high frequency content (including high frequency noise).

In another example, the first processing module 41 is a wind speed estimator that uses a balance of power, in particular between rotor power and electric power generated by the wind turbine 10, taking into account power loss as a result of connection to the grid and other transmission systems. The power balance may be formulated as

$${P}_{r o t} = {P}_{o u t} + {P}_{l o s s} + {P}_{a c c}$$

where Pᵣₒₜ is rotor power, Pₒᵤₜ is electric power, Pₗₒₛₛ is power loss and P_{acc} is the power required to accelerate and decelerate the rotor 104.

This power balance equation may be reformulated as

$$\frac{1}{2} ρ A {V}^{3} {C}_{p} ( λ , θ ) = {P}_{m e a s} + J \dot{ω} ω$$

where Pₘₑₐₛ=Pₒᵤₜ+Pₗₒₛₛ, the power coefficient is a defined function of pitch angle θ and tip speed ratio λ, A is rotor swept area, V is wind speed, ω is rotor speed, and J is inertial moment of the rotor.

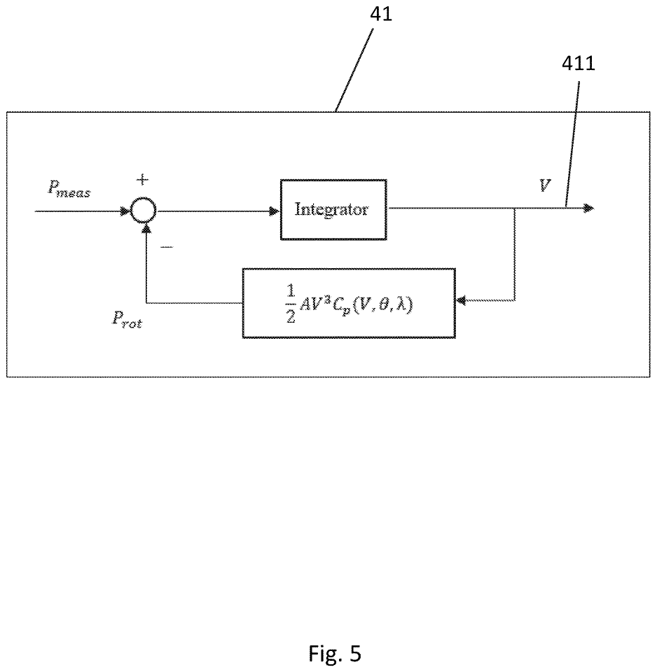

The wind speed estimate can then be estimated as the wind speed that that would generate a power approximately equal to the outputted power by the wind turbine 10. In particular, this can be determined via a feedback loop, which integrates the error between the measured rotor power and the estimated rotor power. Such a feedback loop is illustrated schematically in FIG. 5, which provides the first wind speed signal 411 as an output. Specifically, it is noted that estimating wind speed according to such an integrator approach acts as a low pass filter on the resulting output signal (there is a lag in high frequency content).

An advantage of using the approach outlined in FIG. 4 for determining wind speed when a (power-based) wind speed estimator as illustrated in FIG. 5 is used to determine the first wind speed signal 411 is that the wind speed estimator does not need to be tuned for high frequency content (as this is provided by via the second wind speed signal 421), but instead can be optimised for low frequency content.

The second processing module 42 makes a determination of wind speed changes at the wind turbine 10 caused by high frequency content. In particular, the second processing module 42 makes this determination according to the above-described method of determining wind speed based on estimated or measured thrust force. However, in order that the second wind speed signal 421 only includes wind speed changes as a result of high frequency content, the second processing module 42 needs to apply filtering to filter out low frequency content from the determination (as this is being provided by the first wind speed signal 411).

This filtering may be performed in any suitable manner. For instance, the wind speed may be determined based on obtained thrust force as described above, and the determined wind speed signal may be high pass filtered to remove low frequency content and obtain the second wind speed signal 421.

High frequency content may be defined in any suitable manner. As a purely illustrative example, high frequency content may be content greater than 0.5 Hz. Similarly, low frequency content may be defined in any suitable manner. As a purely illustrative example, low frequency content may be content less than 0.1 Hz. In some examples, high pass filtering may be tuned to pass through content near a first flapwise eigen-frequency of the rotor blade, which will vary depending on the specific size of the rotor and the rotor blade length.

The first and second wind speed signals 411, 421 may be combined in any suitable manner to obtain the (overall) wind speed signal 431. For instance, the first and second wind speed signals 411, 421 may be added together. A factor may be applied to one of the first and second wind speed signals 411, 421 prior to them being combined if the determination from one of the first and second processing module 41, 42 is to be weighted compared to the other.

The output signal 431 indicative of determined wind speed may be used as an input to one or more wind turbine controllers that determine control actions based on current wind speed. In particular, the output signal 431 may be used as an input to one or more wind turbine controllers that are for determining control actions in response to relatively fast changes in wind speed. An example of one such controller may be a thrust limiter controller in which rotor blade pitch angle is controlled to ensure that loading experienced by the wind turbine rotor 104 is kept below a maximum thrust level (thereby reducing fatigue to one or more wind turbine components). As wind gusts can cause relatively fast increases in thrust loading, then a determination of current wind speed that includes high frequency content, i.e. includes wind speed changes over a short timescale (e.g. less than a few seconds, such as less than two seconds), with minimal delay ensures better or optimal performance of such a thrust limiter controller.

As the second wind speed signal 421 is intended to capture relatively fast changes in wind speed, then the second wind speed signal 421 may be updated relatively frequently or substantially continuously to ensure such changes are captured in the determination of current wind speed. The blade flap loads and operating point may be sampled at a defined sampling rate of the controller. The method to obtain the second wind speed signal may be performed on each set of sampled data (blade loads and operating point), i.e. at each time step. Alternatively, the second wind speed signal 421 may be updated at defined time steps, i.e. at defined time intervals. The first wind speed signal 411 may be updated at the same rate as the second wind speed signal 421, or may be updated less frequently than the second wind speed signal 421. The (overall) signal 431 indicative of determined wind speed may be updated at the same rate as the second wind speed signal 421.

Many modifications may be made to the described examples without departing from the scope of the appended claims.

It will be understood that a different defined model or equation for thrust force that depends on wind speed from the one used in the described example above may instead be used in different examples in accordance with the invention.

1. A method of determining wind speed at a wind turbine comprising a rotor and a plurality of rotor blades, the method comprising:
receiving a rotor speed signal indicative of a current speed of the rotor;
receiving a pitch angle signal indicative of a current pitch angle of the plurality of rotor blades;
for each of a plurality of wind speeds, obtaining a first thrust force on the rotor based on the received rotor speed signal and on the received pitch angle signal;
receiving a blade flap load signal, from a blade flap load sensor of each of the rotor blades, indicative of a measured flap loading on the rotor blades;
obtaining a second thrust force on the rotor using a defined blade element model and the received blade flap load signal;
comparing the first thrust forces against the second thrust force, and determining a wind speed based on the comparison.

2. The method according to claim 1, wherein the determined wind speed is the wind speed corresponding to the first thrust force that is closest to the second thrust force.

3. The method according to claim 1, wherein comparing the first thrust forces against the second thrust force comprises performing an interpolation of the first thrust forces to obtain an interpolated function describing thrust force against wind speed, wherein the determined wind speed is the wind speed at which the interpolated function is equal to the second thrust force.

4. The method according to claim 1, wherein each of the plurality of wind speeds are within a defined range of wind speeds and at defined increments within the defined range;
wherein the defined increment is between 0.1 m/s and 2 m/s;
wherein a lower bound of the defined range is between 0 m/s and 5 m/s;
wherein an upper bound of the defined range is between 20 m/s and 40 m/s.

5. The method according to claim 1, the method comprising:
obtaining a first wind speed signal, wherein the first wind speed signal is obtained by estimating wind speed based on one or more received operational parameter signals indicative of current operational parameters of the wind turbine or by measuring wind speed using one or more wind speed sensors of the wind turbine, wherein the first wind speed signal is a filtered signal to retain low frequency content;
obtaining a second wind speed signal, wherein obtaining the second wind speed signal comprises determining wind speed according to the method of any previous claim, and wherein the second wind speed signal is a filtered signal to retain high frequency content; and,
combining the first wind speed signal and the second wind speed correction signal to determine the wind speed.

6. The method according to claim 5, wherein combining the first and second wind speed signals comprises adding the first and second wind speed signals.

7. The method according to claim 5, wherein obtaining the second wind speed signal comprises applying a high pass filter to the wind speed obtained from the comparison of the first thrust forces against the second thrust force.

8. The method according to claim 5, wherein the first wind speed signal is obtained by measuring wind speed using one or more wind speed sensors of the wind turbine, and wherein the method comprises applying a low pass filter to the measured wind speed to obtain the first wind speed signal.

9. The method according to claim 5, wherein the first wind speed signal is obtained by estimating wind speed based on one or more received operational parameter signals indicative of current operational parameters of the wind turbine, wherein the operational parameters include current rotor speed and current pitch angle, and wherein the filtering to retain low frequency content is achieved by one or more of:
applying a low pass filter to the one or more received operational parameter signals; and
applying a low pass filter to the estimation of wind speed.

10. The method according to claim 5, wherein the first wind speed signal is obtained by estimating wind speed based on one or more received operational parameter signals indicative of current operational parameters of the wind turbine, wherein the estimation of wind speed is based on estimated rotor power of the wind turbine, the estimated rotor power being estimated based on one or more operational parameters of the wind turbine, and wherein the estimation of wind speed is obtained using an integral controller and the estimated rotor power.

11. The method according to claim 10, wherein using the integral controller comprises:
receiving a measured rotor power indicative of output power and power loss of the wind turbine;
determining an error between the measured rotor power and the estimated rotor power; and
integrating the error over time to obtain the first wind speed signal.

12. A non-transient, computer-readable storage medium storing instructions thereon that when executed by one or more processors cause the one or more processors to execute a method according to claim 1.

13. A controller for determining wind speed at a wind turbine comprising a rotor and a plurality of rotor blades, the controller being configured to:
receive a rotor speed signal indicative of a current speed of the rotor;
receive a pitch angle signal indicative of a current pitch angle of the rotor blades;
for each of a plurality of wind speeds, obtain a first thrust force on the rotor based on the received rotor speed signal and on the received pitch angle signal;
receive a blade flap load signal, from a blade flap load sensor of each of the rotor blades, indicative of a measured flap loading on the rotor blades;
obtain a second thrust force on the rotor using a defined blade element model and the received blade flap load signal;
compare the first thrust forces against the second thrust force, and determine a wind speed based on the comparison.

14. (canceled)
